(19) United States
(12) Patent Application Publication
(10) Pub. No.: US 2003/0006911 A1
(43) Pub. Date: Jan. 9, 2003

(54) Interactive advertising system and method

(75) Inventors: Brad Smith, London (CA); John Lidzbarski, London (CA)

Correspondence Address: BERESKIN AND PARR, SCOTIA PLAZA, 40 KING STREET WEST-SUITE 4000 BOX 401, TORONTO, ON, M5H 3Y2, CA

(73) Assignee: The Cadre Group Inc.

(21) Appl. No.: 10/023,985

(22) Filed: Dec. 21, 2001

Related U.S. Application Data
(60) Provisional application No. 60/257,098, filed on Dec. 22, 2000.

(51) Int. Cl. G08G 1/123

(52) U.S. Cl. 340/988; 340/990; 340/995; 340/573.1; 340/531; 705/14

(57) ABSTRACT

An interactive advertising system for providing interactive multimedia content to a client positioned in close proximity to an advertising display unit, the interactive advertising system comprising an advertising server, a data communications network, and an advertising platform. The advertising server stores client and advertising databases which contain records relating to the types of clients and the types of advertisements. The advertising server is coupled to the advertising platform over the communications network. The advertising platform comprises a multimedia display, a platform controller, and a GPS receiver. The multimedia display is configured and is controlled by the platform controller to provide interactive multimedia content to a client according to the existing conditions. Conditions can include the specific demographic or psychographic profile of the client, the time of day and the geographical position of the advertising platform. The client can interact with the advertising platform in response to multimedia content and receive coupons and/or purchase items offered through the displayed advertising. The system continuously attracts new clients and tracks, records and quantifies client information over time.

This application claims priority from U.S. Provisional Patent Application No. 60/257,098, filed Dec. 22, 2000.

### FIELD OF THE INVENTION

The present invention relates to systems for providing multimedia advertising to consumers, and more particularly to an interactive advertising system and method.

### BACKGROUND OF THE INVENTION

Traditionally, mobile advertising displays have proven to be an effective advertising medium. Businesses have used mobile advertising systems in various forms, from a person wearing a sandwich board to the visual depiction of certain goods or other indicia representing the source of goods on the side of a truck or other moving vehicle. More recently, public transportation buses entirely wrapped in electrostatic marking film bearing advertising graphics have been utilized within urban areas for their advertising impact on consumers.

However, these prior art advertising displays are unable to effectively deliver an intended message to a target audience based on the audience's demographic composition. For example, a local hardware store in one city neighbourhood might wish to target only customers from that neighbourhood while a toy store in that area may wish to target one type of potential customers (e.g. children) from a larger geographical region. Accordingly, the hardware store prefer to advertise to customers in a particular region of the city while the toy store would like to advertise when its particular target audience would be likely to see the advertisements (e.g. before and after school).

Advertisers and advertising providers attempt to maximize the effectiveness of advertising by targeting certain marketing materials at consumers based on a number of criterion, including time of day, location within an urban environment (e.g. proximity to a particular vendor) and also based on demographics of the particular consumers likely to view the advertising. This kind of targeting advertising is known to substantially increase sales revenues due to a significant increase in advertising value. Typically, targeted advertising is accomplished by associating advertising with advertising outlets in particular urban neighbourhoods or locations, such as by mounting advertising posters in certain neighbourhoods, or along certain traffic routes and by providing advertising in vehicles which only run at certain times of the day (i.e. rush hour overflow buses).

One attempt to target broadcast advertisements at consumers within particular geographical areas is disclosed in U.S. Pat. No. 5,664,948 to Dimitriadis et al. This patent discloses an advertising system which provides for the delivery of preloaded advertising data over conventional radio networks. The system receives broadcast advertising messages which are then transmitted to remote receiving and presentation devices when certain geographical location and time of day conditions are met. Textual and auditory messages are then provided on the presentation devices. However, this system only achieves targeting of consumers based on their geographical location and/or time of day and does not provide any additional criteria on which to further discriminate the provision of the broadcast messages.

Accordingly, conventional advertising methods as well as more advanced broadcasting methods such as the one disclosed in U.S. Pat. No. 5,664,948 discussed above, only approximate the goals of targeted marketing and generally result in only modestly effective advertising. While targeting a certain time of day or geographical area provides advertising to consumers (the majority of which are targeted consumers), a substantial number of non-targeted consumers are also provided with the subject advertising. This can result in wasted advertising resources which can add to business's advertising costs. Further, the overexposure of advertising to non-targeted individuals results in diluted advertising impact. Finally, the types of advertising currently provided in the form of billboard ads and public transport unit mounted ads are limited to passive advertisements and merely provide a message in a particular visual format. The advent of the Internet provides Internet consumers with the ability to interact with an advertiser's Web site (e.g. by clicking through a banner ad and navigating to a promotional Web site). However, this functionality has not been possible hereto in the physical world.

### SUMMARY OF THE INVENTION

One aspect of the present invention is to provide an interactive communication system for providing multimedia content to a client on the basis of a characteristic of the client, the interactive communication system comprising:

(a) a communication server;

(b) a data communication network linked to said communication server;

(c) a handheld device linked to said data communications network;

(d) a communication platform linked to said data communication network, comprising:

(i) a memory for storing the multimedia content and a target client characteristic;

(ii) a processor for determining whether the handheld device is within a predetermined distance of the communication platform;

(iii) a receiver for receiving the characteristic of the client; and

(iv) a display for displaying the multimedia content to the client if the handheld device is within a predetermined distance of the communication system and if the client characteristic is the same as the target client characteristic.

In another aspect, the present invention provides a method for providing multimedia content from a communication platform to a client on the basis of a client characteristic, the method comprising the steps of:

(a) determining whether the client is within a predetermined distance of the communication platform and whether the client characteristic is the same as the target client characteristic; and

(b) if the determinations in (a) are both positive, then displaying the multimedia content to the client.

### BRIEF DESCRIPTION OF THE DRAWINGS

In the accompanying drawings:

FIG. 1 is a block diagram of a preferred embodiment of the interactive advertising system of the present invention;

FIG. 2 is a detailed block diagram of the advertising platform of FIG. 1;

FIG. 3A, 3B and 3C are data structure tables showing the advertiser, client and platform location database records stored on the advertising server of FIG. 1;

FIGS. 4A and 4B are functional flow diagrams illustrating routine process steps that are executed by the advertising server and the advertising platform of FIG. 1 over the communication network of FIG. 1;

FIGS. 5A, 5B and 5C are functional flow diagrams illustrating general operating process steps that are executed by the handheld device, the advertising server, and the advertising platform of FIG. 1;

FIG. 6A is a schematic diagram illustrating how the advertising platform of FIG. 1 utilizes its local data records to determine the advertisement play queue;

FIG. 6B is a table illustrating the basic structure of the play queue generated by the advertising platform of FIG. 1;

FIG. 6C is a schematic diagram of a priority tree used by the advertising platform of FIG. 1 to prioritize advertisements;

FIG. 7A is a schematic diagram of the interactive advertising system of FIG. 1 when advertising platform traverses geographical areas;

FIG. 7B is an event flow chart that illustrates the different queries sent within the interactive advertising system of FIG. 1 as advertising platform traverses different geographical areas;

FIG. 7C is a table showing the location database records of advertising platform of FIG. 1;

FIG. 7D is a play queue showing the position of a location-based advertisement record;

FIG. 8A is an event flow chart that illustrates the different queries sent within the interactive advertising system of FIG. 1 as the time and date changes;

FIG. 8B is a table showing the time database records of advertising platform of FIG. 1;

FIG. 8C is a play queue showing the position of a time-based advertisement record;

FIG. 9A is a schematic diagram of the interactive advertising system of FIG. 1 when client's handheld device of FIG. 1 queries advertising server for information on transport unit arrival times;

FIG. 9B is an event flow chart that illustrates the different queries sent within the interactive advertising system of FIG. 1 as client's handheld device of FIG. 1 queries advertising server for information on transport unit arrival times;

FIG. 9C is a table showing the client database records of advertising platform of FIG. 1;

FIG. 9D is a play queue showing the position of a demographic-based advertisement record;

FIG. 10A illustrates the various play queues that are maintained within the platform database of FIG. 2;

FIG. 10B illustrates the process steps of the QUEUE PLACEMENT routine executed by platform controller 24 to determine which play queue a particular advertisement should be placed into;

FIG. 10C illustrates the process steps of the PLAY ADVERTISEMENT routine executed by platform controller 24 to determine advertisement play sequence;

FIG. 11 is a schematic diagram of the interactive advertising system of FIG. 1 wherein advertising platform is stationary;

FIG. 12A is an event flow diagram illustrating the steps executed within the interactive advertising system of FIG. 1 to provide transport unit arrival time information to clients;

FIG. 12B is a flowchart illustrating the steps executed within the interactive advertising system of FIG. 1 to provide transport unit arrival time information to clients; and

FIG. 12C is a screen capture of the various user interface screens generated on the handheld device of FIG. 12A.

### DETAILED DESCRIPTION OF THE PREFERRED EMBODIMENT

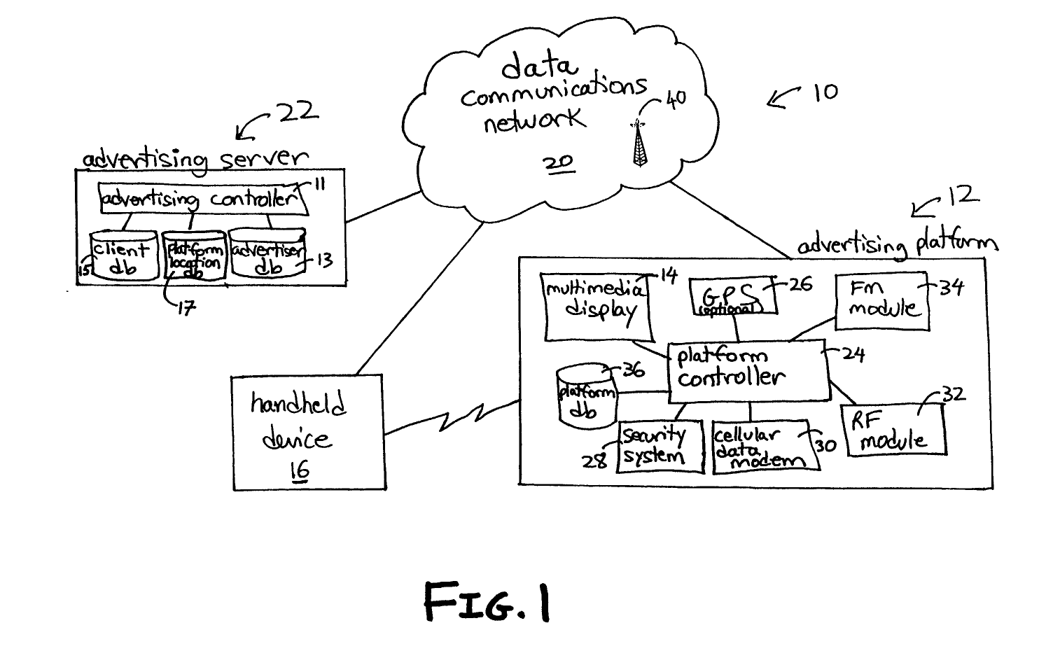

Reference is first made to FIG. 1, which shows a functional block diagram of the interactive advertising system 10 made in accordance with a preferred embodiment of the invention. Interactive advertising system 10 comprises a plurality of advertising platforms 12, each having a multimedia display 14, a plurality of handheld devices 16 associated with subscribed clients, a data communication network 20, and an advertising server 22. Interactive advertising system 10 dynamically provides interactive multimedia content including full motion video, audio and high resolution graphics on selected advertising platforms 12 depending on a number of system monitored parameters such as the geographic location of the advertising platform 12, time and date, and the demographic (e.g. gender, age, family income, etc.) and physcographic (e.g. buying patterns, general buying interests etc,) profiles of the clients, as will be further described.

Advertising platform 12 includes multimedia display 14, a platform controller 24, a security system 28, a cellular data modem 30, a radio frequency (RF) module 32, a FM transmitter module 34, and a platform database 36. Advertising platform 12 is adapted to connect to advertising server 22 over communication network 20, which is typically a wireless network. Further, advertising platform 12 is adapted to interact with handheld devices 16 over a proximity based communication linkup (e.g. Bluetooth type communication). It should be understood that advertising platform 12 can be either mounted in a fixed location (i.e. is geographically stationary) or can be attached to a mobile transport unit (i.e. is geographically mobile) such as a conventional bus or streetcar, taxi, truck, van, tractor trailer, ferry or other water vessel or any type of aircraft, etc.

In the case where advertising platform 12 is attached to a mobile transport unit, advertising platform 12 includes a global positioning system (GPS) receiver 26 and platform controller 24 which are programmed to repeatedly ascertain the specific geographical location of advertising platform 12 (and thus multimedia display 14). Such geographical information is utilized by interactive advertising system 10 to further define what types of interactive multimedia content is to be provided to clients through multimedia display 14. The present invention encompasses the utilization of any of various known location determination systems such as any of those disclosed in U.S. Pat. No. 5,552,772, incorporated herein by reference.

Data communication network 20 is a cellular-based network that provides wireless communication between advertising platform 12 and advertising server 22 through a bearer service provided through cellular nodes depicted by cellular towers 40. It should be understood that the communications link between advertising platform 12 and cellular towers 40 may comprise a conventional cellular link, radio signal broadcast communication, or other known wireless communication systems.

Alternatively, a communications link may be established through a cabled telephone central station network (e.g. in the case of a geographically fixed advertising platform 12). Platform controller 24 receives programming data, multimedia display content as well as associated scheduling data for one or a plurality of different display messages. The data downloaded by platform controller 24 from cellular towers 40 is stored in platform database 36, as will be further discussed. Platform controller 24 thereafter drives multimedia display 14 with the appropriate display message content on the basis of the geographical location of advertising platform 12 as monitored by GPS receiver 26, the date and time of day as ascertained by the clock of platform controller 24, as well as the specific demographic and physcographic profiles of the clients as stored by interactive advertising system 10, as will be further described.

Handheld device 16 may be any kind of personal computing device that includes some form of interactive user interface (e.g. display and keyboard interface, verbal command driven interface, or combinations thereof etc.) such as personal digital assistants (PDA's) (e.g. Palm™, manufactured by Palm Inc. of California), Internet smart phones, personal laptop computers, and the like. Handheld device 16 must contain software programs which provide the necessary communication functionality.

Any required software can be downloaded into handheld device 16 through an on-line download (e.g. from an interactive kiosk). Using conventional server-side technology (e.g. ASP from Microsoft), Web content can be dynamically generated based on embedded scripts in the Wireless Markup Language (WML). When the server executes nested scripting code, pages can be created dynamically with content that is client and time specific. The user can interact with the first such document provided to the client (i.e. “root card”) and appropriate subsequent pages (i.e. “cards”) can contain server-side scripting as well. Automatic position determination of a mobile client physically carrying handheld device 16 requires client registration and the acknowledgement of waivers, as will be described. Demographic information is collected from the client at registration and stored in databases located in advertising server 22, as will be further discussed.

It should be specifically understood that handheld devices 16 could also consist of keyfobs or other personal computing devices, which are capable of holding personal demographic data (or client account information) and which can engage in wireless communication with the RF module 32. Specifically, demographic information contained in a client's keyfob could be read by advertising platform 12 as the client boards the transport unit (e.g. bus) on which advertising platform 12 is mounted.

Advertising server 22 includes an advertising controller 11, an advertiser database 13, a client database 15 and a platform location database 17. Advertising controller 11 maintains data records relating to various advertisers for a variety of identification characteristics (e.g. advertiser identification information such a telephone, address, URL) as well as data records pertaining to multimedia advertisements and presentation preferences (i.e. to determine when a particular advertisement should be performed). Advertising controller 11 also maintains data records relating to various client characteristics (e.g. age, gender, average household income, geographic location, purchasing history etc.) for each client in client database 15. Finally, data records are maintained by advertising controller 11 in respect of the various geographical locations of advertising platforms 12 in platform location database 17, as will be further described.

In this way, a plurality of advertising platforms 12 and handheld devices 16 interact with each other over communications network 20 and using local communication technology (e.g. Bluetooth) and together constitute an advertising computing network which provides rich and informed multimedia content to the clients in possession of handheld devices 16. While the following discussion will focus on the interaction between a single advertising platform 12 and a single handheld device 16, it should be understood that interactive advertising system 10 contemplates the existence of a plurality of advertising platforms 12 and a plurality of handheld devices 16. Further, although the following description will assume the presence of only one advertising server 22, it should be understood that a plurality of appropriately controlled decentralized advertising servers 22 could also be utilized within interactive advertising system 10.

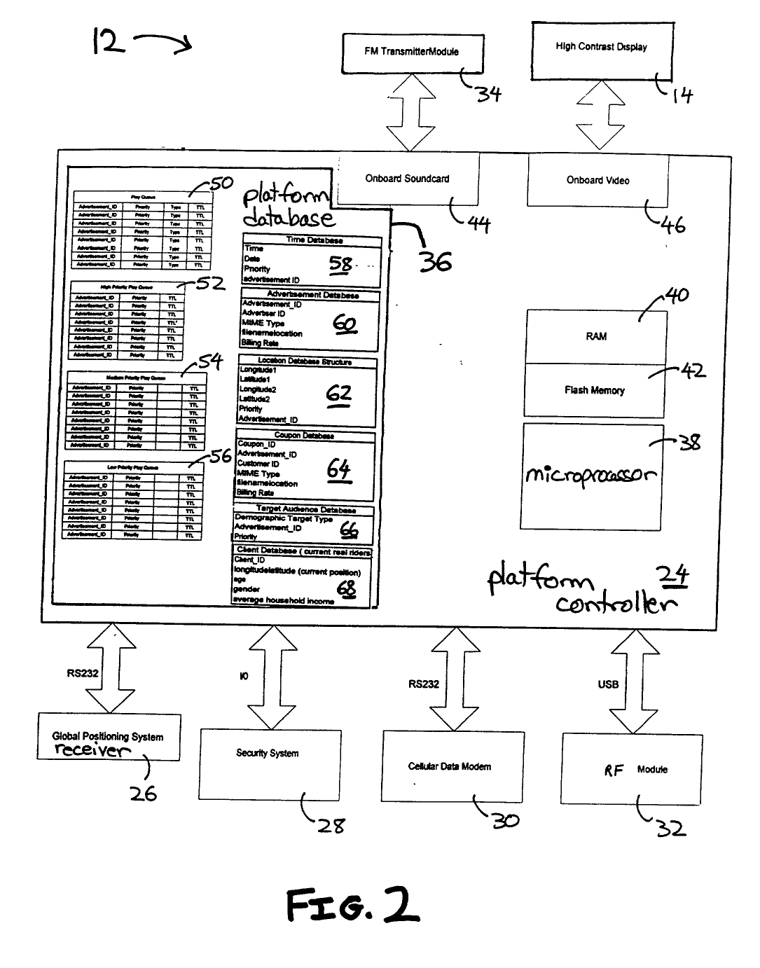

FIG. 2 is a detailed block diagram of advertising platform 12 illustrating the specific components required for operation according to the present invention. As previously discussed, advertising platform 12 includes multimedia display 14, a platform controller 24, a security system 28, a cellular data modem 30, a RF module 32, a FM module 34, and a platform database 36. Advertising platform 12, if mobile, also includes a GPS receiver 26.

Platform controller 24 is an Arcom SBC-MediaGX-233-M32-F16 single board computer with a 32 bit processor 38, 128 Megabytes of RAM 40, flash memory 42, onboard soundcard 44 and onboard video card 46. Platform controller 24 executes a commercially available operating system such as QNX™ Neutrino Realtime OS (manufactured by QNX) a scalable, multi-threaded, fault-tolerant realtime operating system that delivers core realtime services for embedded applications. It should be understood that platform controller 24 can comprise any commercially available microcontroller, memory, data interface modules, and operating system software, as long as these components have sufficient memory and processing speed to achieve the input/ouput and data processing functionality required of advertising platform 12, as will be discussed.

Multimedia display 14 may consist of a variety of known electronically driven dynamic displays which facilitate the display of multimedia advertising content. That is, multimedia display 14 can be any commercially available high contrast flat panel display, high contrast plasma display, and the like (e.g. the 18.1″ Digital SXGA manufactured by NEC). Multimedia display 14 is connected to platform controller 24 through onboard video card 46.

Security system 28 is a conventional security unit adapted to protect advertising platform 12 from vandalism and theft. Security system 28 is programmed to determine when certain components (e.g. multimedia display 14) are being physically compromised and to report such occurrences by transmitting a suitable distress signal over communication network 20 to advertising server 22 which in turn, alerts the advertising server administrator. Security system 28 is connected to platform controller 24 through the I/O port of platform controller 24.

Cellular data modem 30 is a conventional cellular modem which provides cellular communication between advertising platform 12 and communication network 20 such as the MP210 multi-mode cellular modem manufactured by Sierra Wireless Inc. of Richmond, British Columbia which uses Circuit Switched Cellular (CSC) and Cellular Digital Packet Data (CDPD) when available or the Sage cellular modem manufactured by Novatel of San Diego, Cali. Data is communicated between cellular data modem 30 and platform controller 24 according to the RS232 protocol.

RF module 32 is a commercially available radio frequency module which supports a local area communication protocol such as the Bluetooth Specification. The Bluetooth Specification is a de facto standard containing the information required to ensure that diverse devices supporting the Bluetooth wireless technology can communicate with each other world wide. Communication between advertising platform 12 and handheld device 16 is facilitated using a Bluetooth compliant communication card, such as The Bluetooth Core™ (manufactured by Ericsson).

Accordingly, handheld device 16 can be connected into a Local Area Network (LAN) through advertising platform 12 acting as a LAN Access Point (LAP). Once connected, handheld device 16 will operate as if it were connected to the LAN via dial-up networking and handheld device 16 can access all of the services provided by the LAN. It should be understood that this LAN-handheld device communication can be established for a plurality of handheld devices (i.e. a number of clients who are physically close enough to advertising platform 12 so as to be recognized.

The Bluetooth Core™ is a fully functional Bluetooth interface communication system which includes a Radio Module™ transceiver, a Baseband™ processor and Link Manager™ software (not shown). RF module 32 interfaces with platform controller 24 using the USB communication protocol. The Radio Module™ is a complete short-range radio transceiver with external antenna and clock reference. The Baseband™ processor specifies the procedures to support exchange of real-time voice and data information, as well as networking between Bluetooth units. Finally, the Link Manager™ software carries out protocols for link up, authentication, link configuration, and the like. Specifically, the Link Manager™ software discovers other remote Bluetooth units and communicates with them via the link manager protocol. This software provides services such as name request, link address inquiries, connection set-up, authentication, link mode negotiation and set for data and voice and control of the power mode of RF module 32.

FM module 34 is coupled to platform controller 24 through onboard sound card 44. FM transmitter module 34 includes any commercially available FM stereo transmitter integrated circuit such as the Wireless Audio Link IC™ Part No. BH1416F (manufactured by Rohm), which consists of a stereo modulator for generating stereo composite signals and a FM transmitter for broadcasting a FM signal on the air. FM transmitter module 34 is utilized within interactive advertising system 10 to provide enhanced audio content to clients who are in close proximity to advertising platform 12 and who are also listening to portable audio devices (e.g. Walkman radio player manufactured by Sony) or a cellular phone which contains Bluetooth communication facility (e.g. Ericson manufactured cell phone) or FM communication capability (e.g. Fido manufactured cell phone). The specific type of audio programming contemplated by the present invention will be discussed in more detail.

Platform database 36 includes a number of individual databases, specifically a play queue database 50, a high priority play queue 52, a medium priority play queue 54, a low priority play queue 56, a time database 58, an advertisement database 60, a location database 62, a coupon database 64, a target audience database 66, and a proximate client database 68. These databases are all stored in non-volatile memory and are derived from corresponding databases located on advertising server 22. The specific relationship and content of these various databases on advertising server 22 and platform database 36 will be further discussed.

GPS receiver 26 is a conventional GPS receiver and interfaces with platform controller 24 using the RS232 protocol. GPS receiver 26 can be any commercially available GPS receiver, such as the PCMCIA Pathfinder™ Card (manufactured by Trimble Navigation Ltd.) for receiving information from three or more GPS transmiters. GPS receiver 26 receives these signals and converts them to a specific latitude and longitude (and in some cases altitude) coordinate data. GPS receiver 26 provides the coordinate data to platform controller 24 for processing.

It should be understood that the geographical locating features of GPS receiver 26 could be alternatively accomplished using conventional cellular triangulation methods, such as those utilized by positioning systems sold under the trade names TruePosition™ (manufactured by Liberty Media), Sigma™ (manufactured by Tadiran) and Cell-Loc™ (manufactured by Cell-Loc). In such a case, it would not be necessary to utilize GPS receiver 26 within advertising platform 12.

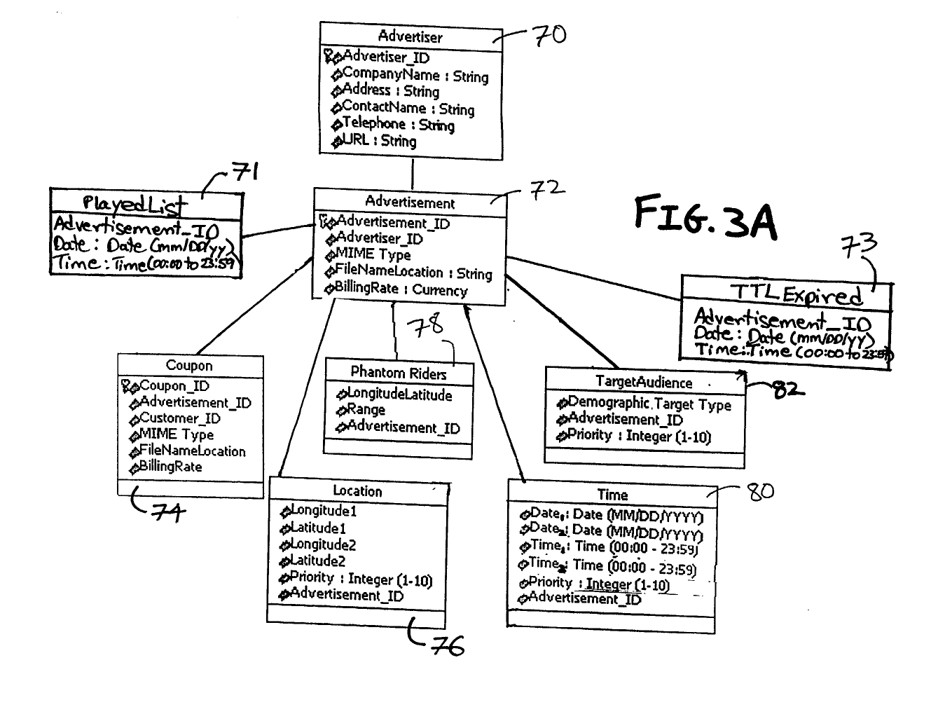

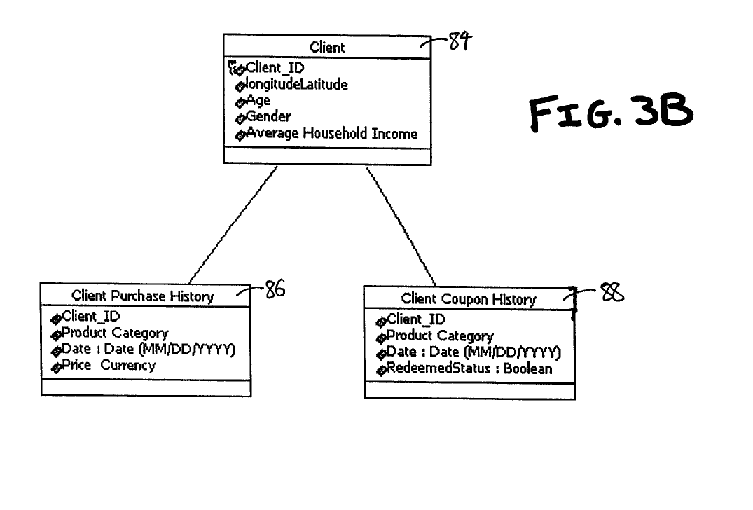

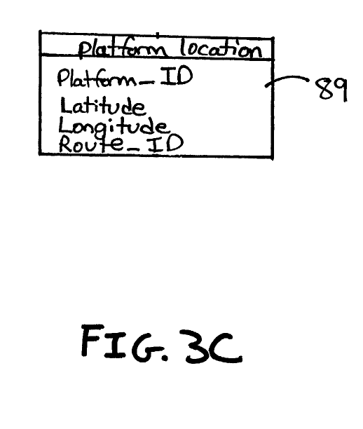

FIGS. 3A, 3B and 3C illustrate the data structure of the data records stored within advertiser database 13, client database 15, and platform location database 17, respectively, all of which reside on advertising server 22. These databases are responsible for tracking the location of the various advertising platforms 12, storing the various advertisements associated with various advertisers, and prioritizing advertisements based on the match of target demographic characteristics with actual demographic characteristics of clients which are coming into local communication with advertising platforms 12.

As shown in FIG. 3A, advertiser database 15 consists of advertiser records 70, advertisement played list records 71, advertisement records 72, Time To Live (TTL) expired records 73, coupon records 74, location records 76, phantom riders 78, time records 80, and target audience records 82. The data records contained in advertiser database 15 are used to track various attributes of the system's advertisers, their advertisements and the target demographic characteristics for a particular advertiser's advertisement.

Advertiser records 70 consist of particulars relating to the various advertisers that have subscribed to interactive advertising system 10, namely Advertiser_ID, CompanyName, Address, ContactName, Telephone, and (Web address) URL. This general contact information is used to track individual advertisers for administration and billing purposes.

Advertisement played list records 71 consist of an Advertisement _ID and an associated time when the Advertisement_ID was played. These records keep track of when an advertisement was last played within interactive advertising system 10.

Advertisement records 72 consist of particulars associated with a particular advertisement. It should be understood that each advertiser typically has a plurality of advertisements, each advertisement having their own set of particulars. Advertisement ID, Multipurpose Internet Mail Extension (MIME) Type (i.e. to allow for proper streaming of Web content), as well as other administrative data such as FileNameLocation and BillingRate are tracked for each advertiser's advertisement.

Time To Live (TTL) expired records 73 consist of an Advertisement _ID and an associated time when the Advertisement_ID was removed from the play queue. These records keep track of how long advertisements have been at the bottom of a play queue and is used by interactive advertisement system administrator to determine which advertisements are not being properly utilized within the advertising system.

Coupon records 74 consist of particulars associated with various promotional coupons which are provided by advertisers to clients. For example, each coupon will have an identifier, an Advertisement_ID to indicate the advertisement that the coupon is associated with, a Customer_ID to identify which customer has been issued the coupon, MIME Type as well as other administrative data such as FileNameLocation and BillingRate.

Location records 76 are kept by advertising server 22 to define the particular geographic area in which a particular advertisement is to be performed. The values Longitude1/Latitude1 and Longitude2/Latitude2 are used to define such a geographical area. The value Priority (with an integer value from 1 to 10) is used to assign a particular priority (ie. for determination of play order by advertising platform) to an advertisement. Advertisement_ID identifies the particular advertisement associated with a particular location record.

Phantom Riders records 78 are used by interactive advertising system 10 to ensure that advertising platform 12 displays a default set of advertisements when clients are not in close proximity to advertising platform 12. This ensures that unsubscribed (e.g. potential) clients or consumers that are not in possession of handheld device 16 will still be provided with some level of targeted advertising. Specifically, advertising will be targeted based on general survey results and applied on the basis of geography (i.e. the geographic location of advertising platform 12) and time of day.

It is contemplated that ongoing studies of transit riders will establish ridership profiles for each specific transit route that include demographic and psychographic information in certain key urban locations (e.g. main business, shopping, educational districts of a city, etc.) Such marketing surveys along with ridership volumes on each transit route at a given time will allow interactive advertising system 10 to “fill” advertising platform 12 with a statistically correct population of phantom riders (i.e. as stored in phantom riders records 78 in advertiser database 13). As ‘real’ clients enter the transit vehicle, interaction between their handheld device 16 (e.g. PDA or cell phone) and platform controller 24 will “displace” phantom riders.

The Longitude, Latitude and the Range values represent a geographical center point and a radius, respectively which together define a region within which a particular advertisement should be played. Advertisement_ID identifies the particular advertisement associated with a particular phantom rider record.

Time records 80 are used to set up priority information for advertisements based on the time and date criterion. Specifically, Date, and Date₂ (month, day, year) are used to record the particular date range during which an advertisement is scheduled to be played. Time₁ and Time₂ (calculated on the basis of a 24 hour clock) are used to record the particular times that an advertisement should be played at for a particular date range. Priority (with an integer value from 1 to 10) is used to assign a particular priority to an advertisement. The priority variable will be used by advertising platform 12 to make a further determination of play order in real time. Advertisement_ID identifies the particular advertisement associated with a particular time record.

Target Audience records 82 are used to associate demographic characteristics with a particular advertisement. That is, interactive advertising system 10 will not allow for display of a particular advertisement, as identified by Advertisement_ID until a client enters into local area communication with advertising platform 12 having demographic characteristics which are substantially similar to a preset Demographic Target Type. Again, Priority (an integer value of 1 to 10) is associated with a particular TargetAudience record for use by advertising platform 12 when constructing the play queue.

As shown in FIG. 3B, client database 15 consists of client records 84, client purchase history records 86 and client coupon history records 88. Client records 84 consist of information relating to a particular client subscriber to interactive advertising system 10. That is, a Client_ID (i.e. a client system identifier), the client's LongitudeLatitude (i.e. the client's location), Age, Gender and Average Household Income (i.e. various client demographic characteristics of interest).

Client purchase history records 86 are kept for each purchase for each client subscriber. Specifically, a Client_ID, Product Category (e.g. entertainment, food, clothing, etc.), as well as the Date, and Price. This information is used by interactive advertising system 10 to more effectively target clients based on their purchase histories.

Client coupon history records 88 include the variables Client_ID, Product Category, Date, and RedeemedStatus (a boolean value) which reflect critical information about a client's coupon history. Again, this information can be used by interactive advertising system 10 to more effectively target clients based on their coupon history (i.e. whether a client in fact redeems coupons or not).

As shown in FIG. 3C, platform location database 17 consists of a collection of location records 89. Each location record 89 contains the geographical location of a particular advertising platform 12 and a route description identifier for the purposes of allowing interactive advertising system 10 to provide route specific information to client, as will be further described. Specifically, a particular Route_ID is assigned to each advertising platform 12 on a routine basis (i.e. when advertising platforms 12 are moved between routes). Also, a pair of Longitude and Latitude values are recorded for each particular AdvertisingPlatform_ID by advertising controller 11 on a regular and routine basis, as will be described.

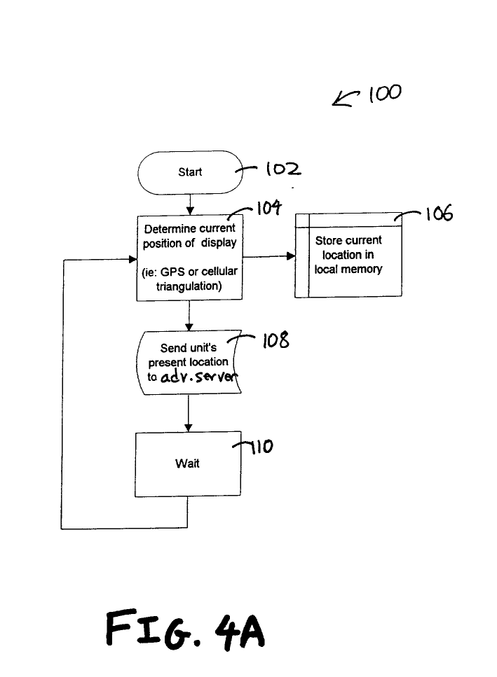

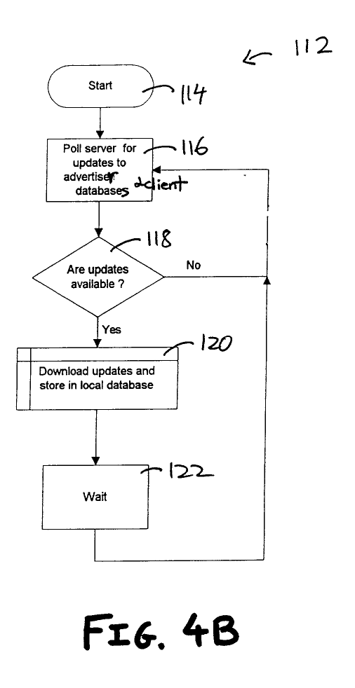

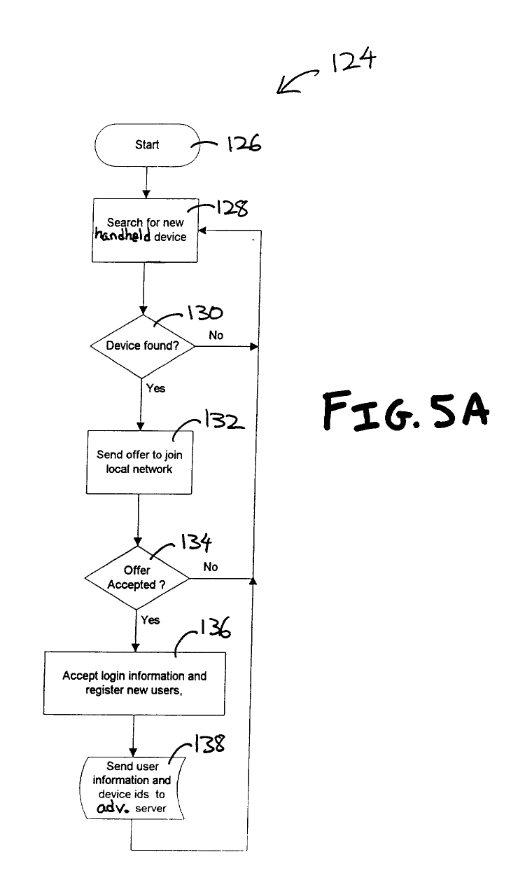

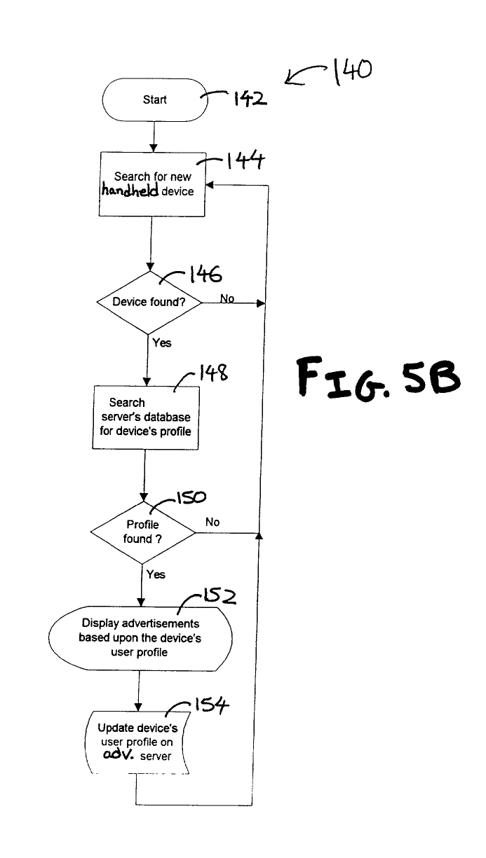

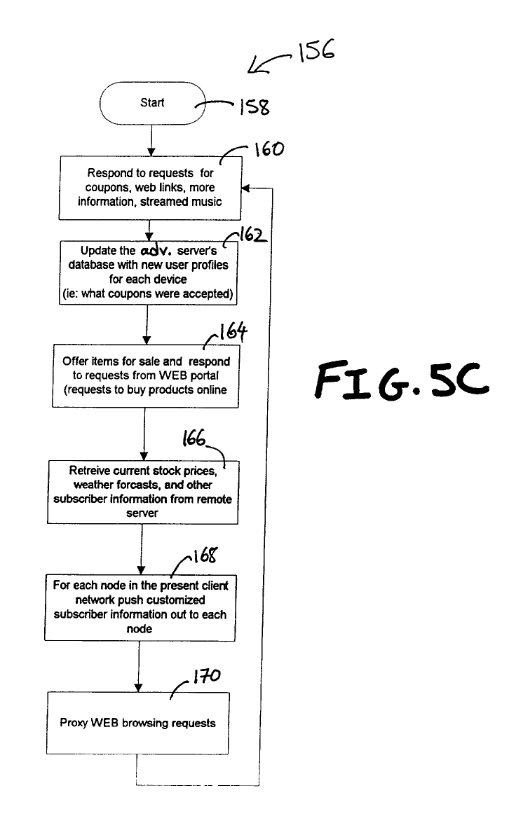

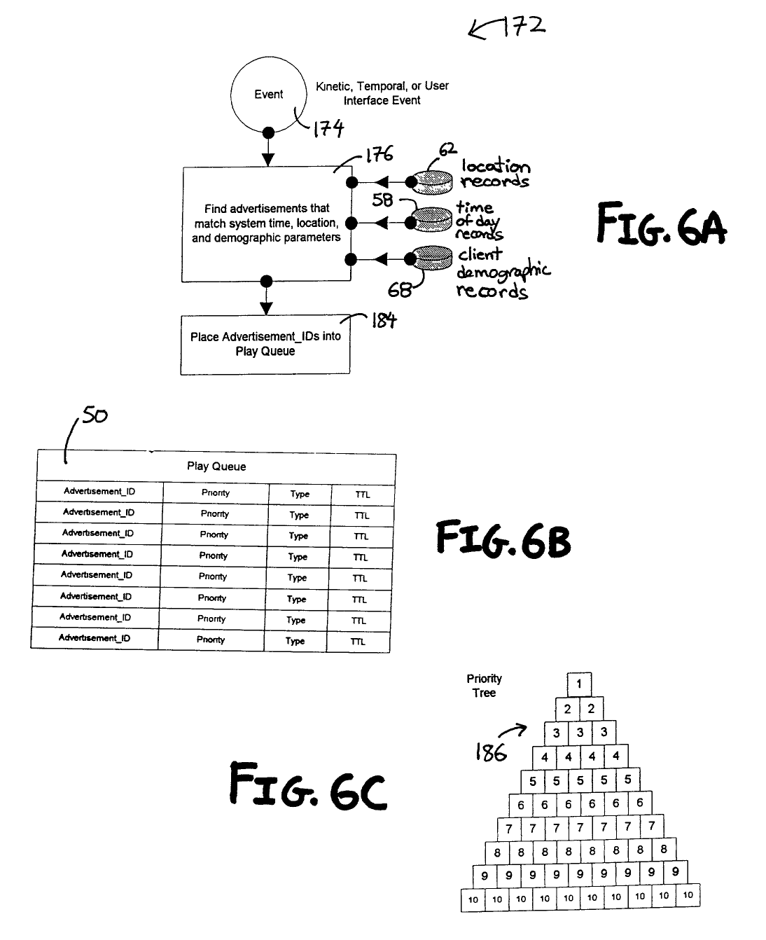

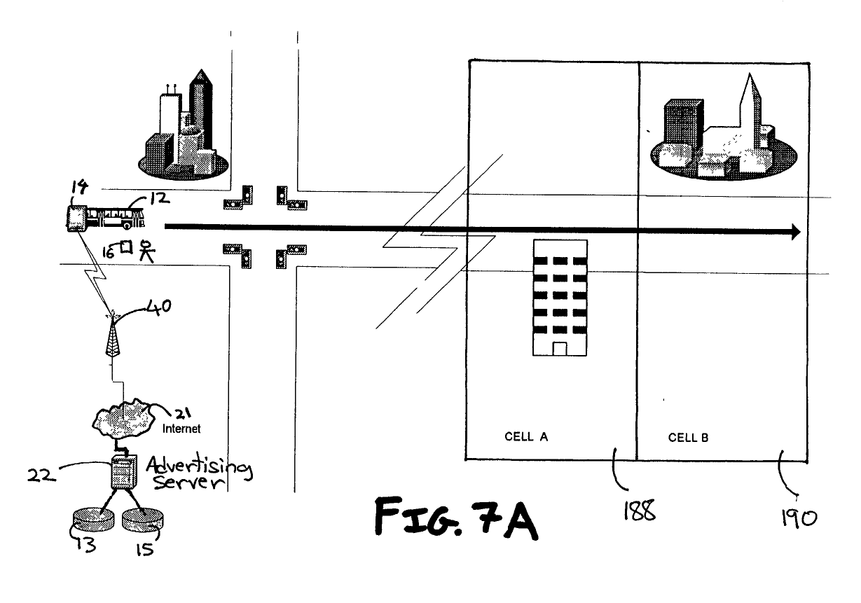

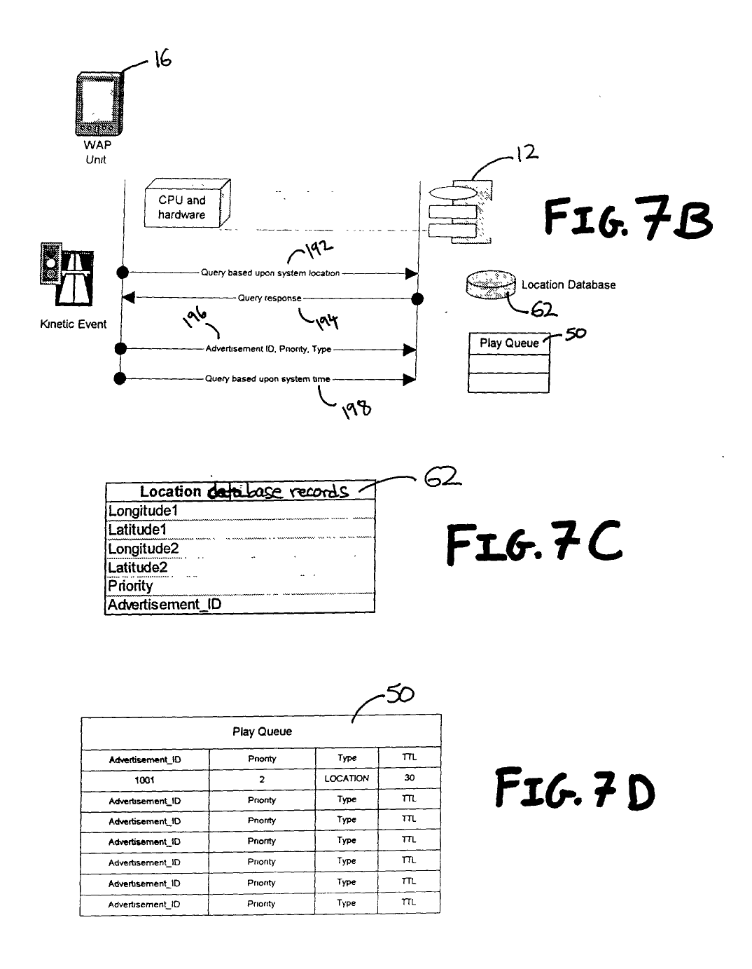

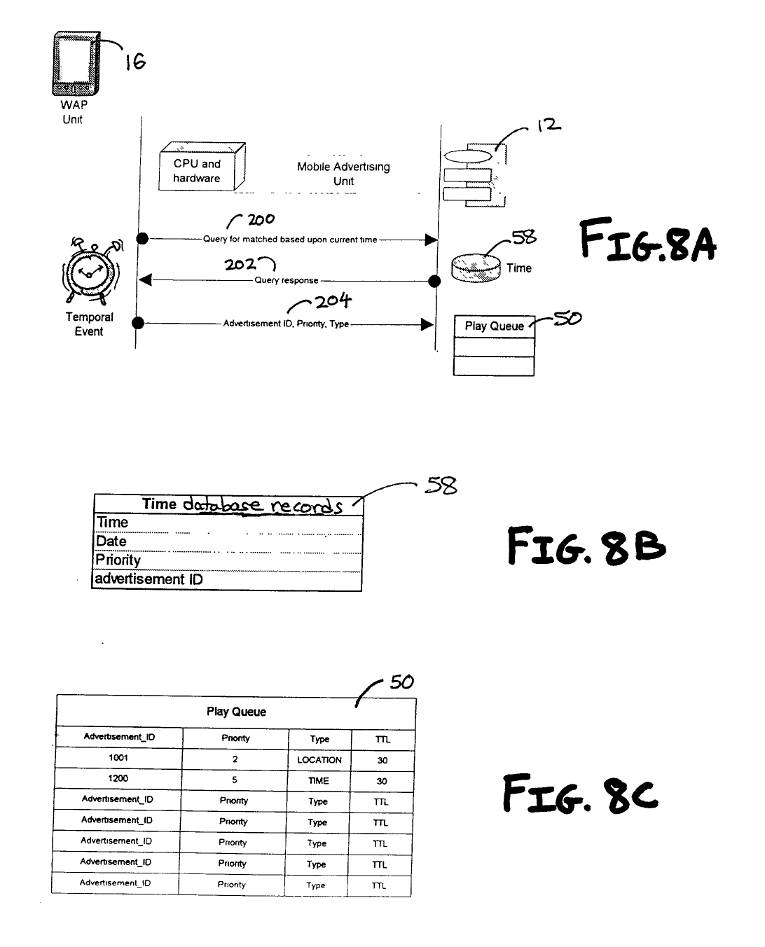

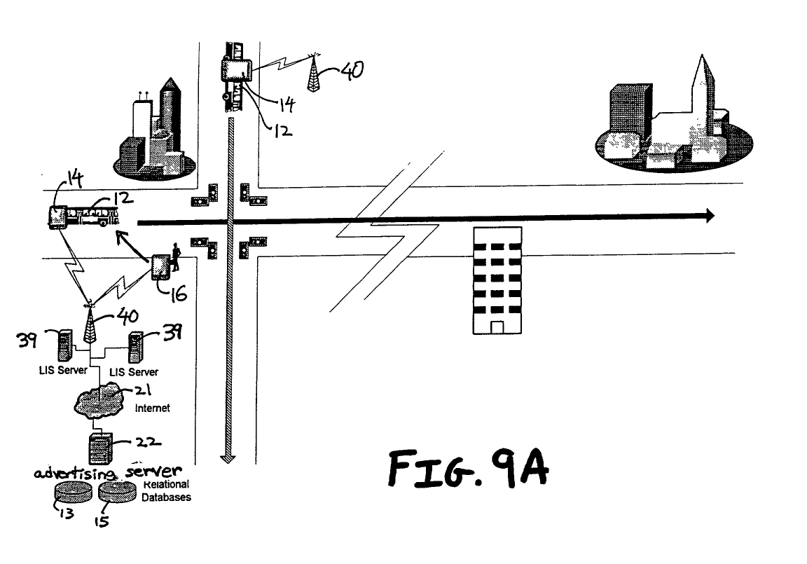

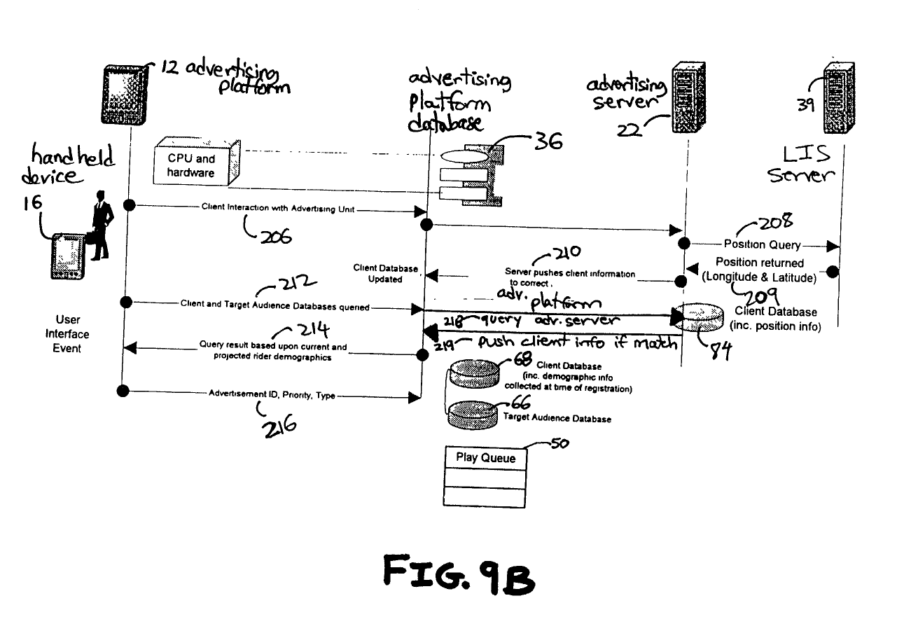

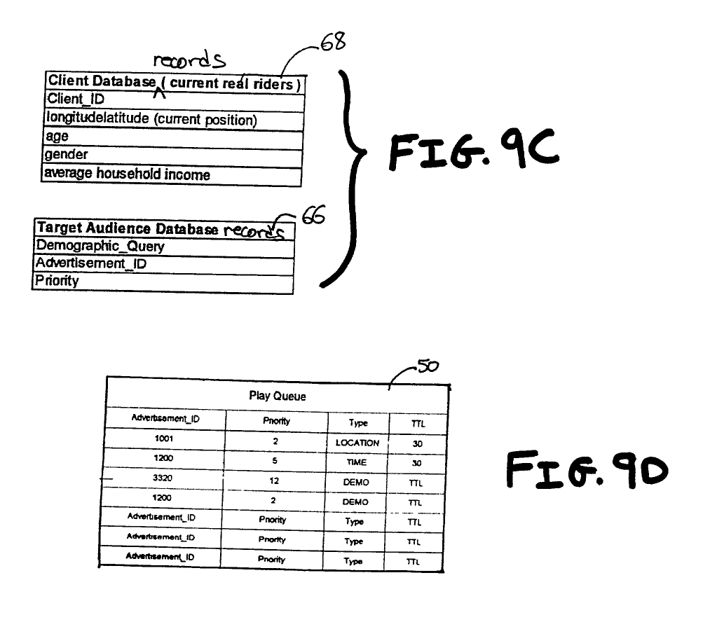

FIG. 4A shows the general data maintenance process steps 100 that are executed by platform controller 24 of advertising platform 12 and advertising controller 11 of advertising server 22 for maintaining updated database records. These steps require the communication and exchange of data over communication network 20 as will be described in more detail. The position of advertising platform 12 is used to determine which multimedia data is downloaded and stored in the local database 36 of each advertising platform 12 as well as for client navigational purposes, as will be described.

Specifically, interactive advertising system 10 determines the current position of advertising platform 12 and provides this information to advertising server 22 on a regular basis. This process starts (102) and then determines the current position of multimedia display 14 (104) using either GPS or cellular triangulation techniques as have been described. This information is stored in the local memory (i.e. flash memory 42) of advertising platform 12 (106) and simultaneously sent to advertising server 22 (108).

A predetermined time interval is allowed to elapse and then the current position of advertising platform 12 is again determined (at 104) and so on. This process is continually executed for all the advertising platforms 12. In the case of a stationary advertising platform 12, the geographical location of advertising platform 12 will not change and it is contemplated that advertising controller 11 could be programmed not to execute these process steps in respect of a fixed advertising platform 12.

FIG. 4B illustrates another set of data maintenance process steps 112 that are executed by platform controller 24 of advertising platform 12 and advertising controller 11 of advertising server 22 for synchronizing the database records of platform database 36 with those maintained by advertising server 22. In a preferred embodiment, advertising server 22 maintains the master record of all advertising and client records within advertiser database 13 and client database 15. Advertising platform 12 continually reads and updates its own platform database 36 based on advertising server's 22 records. This allows advertising platform 12 to provide constantly updated advertising content to subscribed clients as recorded in real time within the databases of advertising server 22.

Specifically, advertising platform 12 queries advertising server 22 on a regular basis to obtain a current set of advertising and client records for storage within platform database 36. This process starts at step 114 and then queries advertising server 22 for updates to the advertisement records within advertiser database 13 and records within client database 15 (116). If updates are not available (118) then the process returns and re-queries advertisement server 22 (116). If so, then advertising platform 12 downloads the updates and stores them (120) in the appropriate records of platform database 36. A predetermined time interval is allowed to elapse and then the current position of advertising platform 12 is again determined (122) and so on. This process is executed for all the advertising platforms 12 simultaneously or in an efficient serial manner.

FIG. 5A shows the general operating and communication steps that occur between advertising platform 12 and a handheld device 16 through local communication and between advertising platform 12 and advertising server 22 over communications network 20 in the case of a mobile advertising platform 12. Generally, each time a client carrying a handheld device 16 enters a transport unit associated with advertising platform 12, platform controller 24 receives information from client and transmits it to advertising server 22, if appropriate.

Specifically, the process begins (126) and then platform controller 24 continuously searches the immediate area using RF module 32 to initiate contact with handheld devices 16 that have not yet been detected (128). It should be understood that the physical range of this searching will depend on the specific range of RF module 32. Platform controller 24 then determines if a handheld device 16 has been located by RF module 32 (130). If not, then platform controller 24 continues to search for a new handheld device (128). If so, then platform controller 24 through RF module 32 sends an offer to handheld device 16 to join the local network associated with advertising platform 12 (132).

It is then determined whether the offer is accepted by user on handheld device 16. If not, then the search for a new handheld device 16 is continued (128). If so, then login information is accepted from existing clients and registration information is accepted from new clients (136). Finally, client information and handheld device identification information is sent to advertising server 22 (138) and platform controller 24 then continues to search for a new handheld device 16 (128).

FIG. 5B shows the general operating and communication steps that occur between advertising platform 12 and handheld device 16 through local communication and between advertising platform 12 and advertising server 22 over communications network 20 in the case where advertising platform 12 is stationary. Generally, each time client carrying a handheld device 16 comes into physical proximity of a stationary advertising platform 12, platform controller 24 receives information from client and provides appropriate advertising content to client as determined by the client's characteristics, (e.g the client's demographic profile, as well as their coupon redeeming and purchase history), as will be further described.

Specifically, the process begins at step 142 and then platform controller 24 continuously searches the immediate area using RF module 32 to initiate contact with handheld devices 16 that have not yet been detected (144). It should be understood that the physical range of this searching will depend on the specific range of RF module 32. Platform controller 24 then determines (146) if a handheld device 16 has been located by RF module 32. If not, then platform controller 24 continues to search for a new handheld device (144). If so, then platform controller 24 posts a query to advertising server 22 to identify whether a client profile (i.e. associated with the handheld device 16) is contained within client database 15 (148).

Platform controller 24 then determines (150) whether the particular client profile has been found. If not then platform controller 24 then continues to search for a new handheld device (144). If so, then platform controller 24 instructs multimedia display 14 to display advertisements based upon the client profile, as will be further described. After display (and possibly after advertising platform/client interaction), advertising platform 12 sends any updated data relating to the client's profile (i.e. if they have redeemed a coupon) to advertising server 22 in order to update the appropriate records in client database 15.

FIG. 5C shows in more detail the specific types of advertising services which can be provided by interactive advertising system 10 to a client though their handheld device 16. Specifically, the process starts at 158. During the multimedia display of advertising to client, advertising platform 12 responds to client requests (160) for coupons, Web links, more information concerning the advertisement as well as streamed music (as provided by the FM module 34). After the interaction between client and advertising platform 12 is concluded, advertising platform 12 sends a message to advertising server 22 to update the data records associated with the client profile (162) including such data as what coupons were accepted by the client.

It is contemplated that items featured in the advertisements can also be offered for purchase (164) by the client and Web site requests for purchase (i.e. requests to purchase the advertiser's products and/or services on-line) can be provided by advertising server 22 either through an internet connection over communications network 20 or through advertising platform 12. In addition, it is also contemplated that information such as current stock prices, weather forecasts, and other client subscriber information can be retrieved from advertising server 22 by advertising platform 12. It is also contemplated that customized information (i.e. information from particular sources, etc.) be “pushed” to individual clients through their handheld devices 16 based on their pre-selected preferences (168). Proxy Web browsing requests (170) are administered by advertising platform 12 acting as an Internet bridge. Advertising platform 12 connects with handheld devices 16 directly through a wireless connection and then in turn connects to the Internet through communications network 20.

Finally, it is contemplated that in relation to providing streamed music (160), the invention would provide simultaneous broadcast of audio using a Bluetooth enabled handheld device 16. Once the client's handheld device 16 has joined the local communication network of advertising platform 12, the audio portion of the presentation may be received by the client. For example, in the case where the client can be presented with an advertisement for a newly released music CD that includes both audio segments from the music CD itself as well as video segments of the performer. The client would then be encouraged to purchase the music CD directly using their handheld device 16 through advertising platform 12 over the local communications link. The client could then purchase the music CD by utilizing the capabilities of a Wireless Application Protocol (WAP) enabled device or utilizing a Bluetooth device that communicates through advertising platform 12 acting as a Web portal to the World Wide Web. It should be noted that it would be possible for client to download the music directly into their handheld device 16. Finally, the client could be provided with digital coupons which could be redeemed at the time of remote purchase.

FIG. 6A is a schematic process flow diagram 172 illustrating the steps executed by platform controller 24 of advertising platform 12 to determine the advertisement play queue for advertising platform 12 on the basis of the various data records stored in platform database 36. FIG. 6B illustrates the basic structure of play queue 50 which is generated by advertising platform 12.

Specifically, it is contemplated that when an event occurs (174), platform controller 24 will begin the process of determining an advertisement play queue 50 (see FIGS. 2 and 6B). The specific types of events contemplated are either kinetic (e.g. there is a change in the geographic location of advertising platform 12), temporal (e.g. changing time of day), and client (e.g. a client with particular demographic profile comes into proximate contact with advertising platform 12).

When platform controller 24 determines that such an event has occurred, then it determines (176) which advertisements (as defined by the advertisement records 60 within platform database 36) substantially match the geographic, time of day and client demographic parameters as recorded within the location records 62, time of day records 58 and client records 68 of platform database 36. The advertisements which match these parameters are then ordered by Priority and placed (by Advertisement_ID number) into a play queue 50 (FIG. 6B).

The play queue 50 shown in FIG. 6B also includes Type (e.g. location, time or demographic type) and the “time to live” (TTL) data is stored in play queue 50. When an advertisement_ID is placed into play queue 50, the advertisement_ID is assigned a “time to live” (TTL) integer value. The TTL value for each Advertisement_ID in play queue 50 is reduced by one whenever an Advertisement_ID is removed from play queue 50 for play. It is conceived that Advertisement_IDs may enter play queue 50 but may never be selected for play back as a result of new advertisements entering with a higher priority. If the TTL value for an Advertisement_ID reaches 0, then the Advertisement_ID is removed from play queue 50, a record of this removal is made in the appropriate TTL Expired record 73 in the advertiser database 13 on advertising server 22. This allows the interactive advertising system administrator to adjust priority levels of Advertisement_IDs which are not being played to ensure all advertisements get a ‘fair’ chance to play back. This failsafe mechanism also prevents play queue 50 from becoming deadlocked. The specific process whereby play queue 50 is built will be further described.

Finally, FIG. 6C shows a priority tree 186 which illustrates the priority order of various advertisements. The assignment of priority is pre-determined by the advertising server administrator when the advertising records are first installed within advertiser database 13, presumably charging an advertiser more for a higher level of priority. For example, an advertisement that has been assigned a priority of level 1 will supersede the playback of an advertisement assigned a priority of level 10. Up to ten priority level 10 advertisements may be assigned as indicated in priority tree 186. The specific interworking of priority queue 50 and priority tree 186, will be further described.

FIGS. 7A, 7B, 7C and 7D illustrate how play queue 50 is built in the case of a location event. That is, in the case where advertising platform 12 enters another geographical area.

FIG. 7A illustrates a portion of the geographic region serviced by advertising platform 12, showing how the portion is divided into two rectangular cells 188 and 190. It should be understood that while only two cells are discussed for illustrative purposes, in practical application several hundred cells would be utilized by interactive advertising system 10. Each cell 188 and 190 is bounded by pairs of longitude and latitude coordinates and are recorded in the Location database records 62 of platform database 36 as “Longitude 1” and “Latitude 1” and “Longitude 2” and “Latitude 2” as discussed and shown in FIG. 7C.

As previously discussed, advertising platform 12 is coupled to advertising server 22 through communications network 20, which can comprise a plurality of cellular towers 40 and an Internet connection 21 as shown. Advertising platform 12 periodically polls advertising server 22 in order to update the database records of platform database 36. While this polling is taking place, advertising server 22 calculates the current position of advertising platform 12 and updates the advertising platform location database 17. This location is also returned to advertising platform 12 and the returned information is recorded in platform database 36.

Each cell 188 and 190 can be assigned more than one advertisement (i.e. more than one Advertisement_ID). These advertisements are displayed on multimedia display 14 as advertising platform 12 travels through the region. Since multiple advertisements can be assigned to each cell 188 or 190, a priority value is assigned amongst the various advertisements for a particular cell in order to built a preferential play queue 50. For example, an advertisement that has been assigned a priority of level 1 will supersede the playback of an advertisement assigned a priority of level 10 as shown in the priority tree 186 of FIG. 6C. As discussed above, the assignment of priority is pre-determined by the advertising server administrator when the advertising records are first installed within advertiser database 13.

FIG. 7B illustrates the process that occurs when there is a location event (i.e. advertising platform 12 has entered a new cell). The new position of advertising platform 12 is used to determine which advertisements should be displayed on multimedia display 14. A query is sent (192) to platform database 36 for advertisements that are slated to be presented for the new location of advertising platform 12. The database query returns (194) the Advertisement_ID of each record of the Location database records 62 held by platform database 36 that matches the current (new) location of advertising platform 12.

FIG. 7D illustrates a typical play queue 50 record. Results placed into play queue 50 as a result of a location query are marked as type LOCATION and assigned a priority to prepare for display. Only one unique Advertisement_ID can be entered into play queue 50 as a result of a location query. That is, no duplicates of a particular Advertisement_ID can be entered into play queue 50 for of type LOCATION. Attempts to enter an identical Advertisement_ID of Type LOCATION will result in the original being overwritten.

FIGS. 8A, 8B, and 8C illustrate how play queue 50 is built in the case of a time of day event. That is, platform database 36 is queried to identify advertisements that correspond to a current date and time.

FIG. 8A shows how the current time of day is used to determine which advertisements should be displayed on multimedia display 14 according to a time schedule as recorded in the Time data records 58 (FIG. 8B) within platform database 36. The current day is broken up into time slots of a predetermined length. Each time slot can be assigned more than one advertisement (i.e. number of Advertisement_IDs). These advertisements could be displayed as advertising platform 12 travels during a given time of day. Since multiple advertisements can be assigned to each time slot, the ability to assign a priority allows certain advertisements to be selected for preferential playback in respect of others.

A query is sent (200) to platform database 36 for advertisements that are slated to be presented for the current date and time. The database query returns (202) the Advertisement_ID of each record of the Time database records 58 of platform database 36 that matches the current date and time. Only one unique Advertisement_ID can be entered into play queue 50 as a result of a time query. That is, no duplicates of a particular Advertisement_ID can be entered into play queue 50 of type TIME. Results placed into play queue 50 as a result of a time query are marked as type TIME and assigned a priority as illustrated in FIG. 8C. to prepare for display. Attempts to enter an identical Advertisement_ID of Type TIME will result in the original being overwritten.

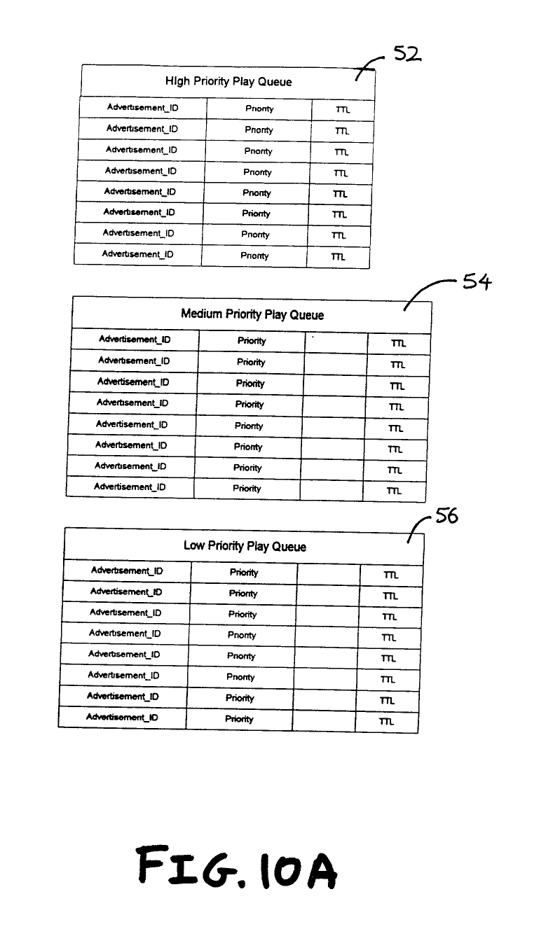

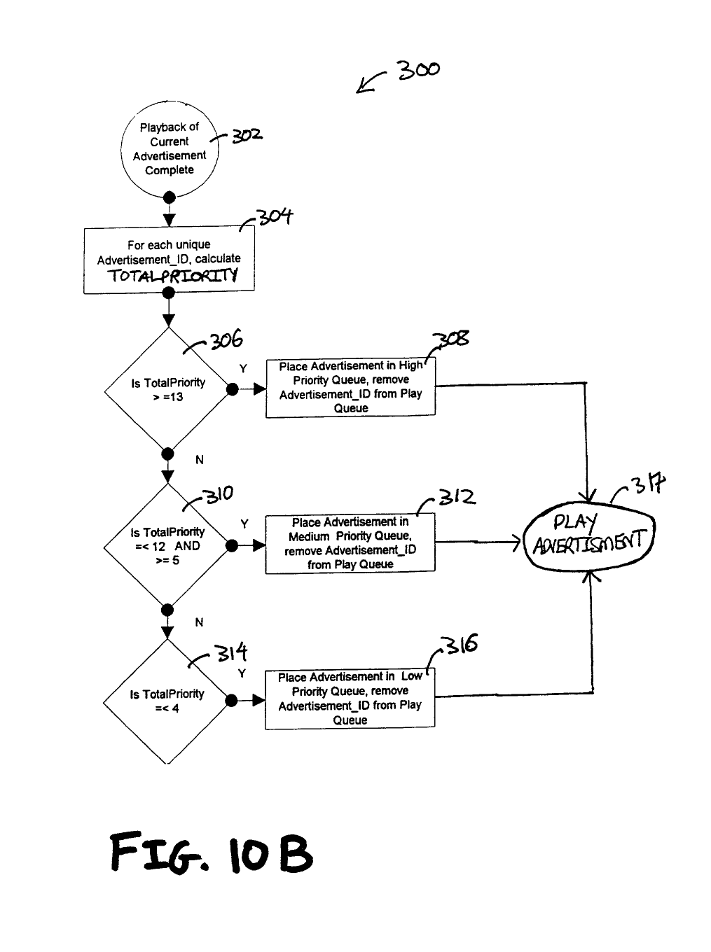

FIGS. 9A, 9B, 9C and 9D show how play queue 50 is affected by the occurrence of a user event within interactive advertising system 10. That is, a user is identified by advertising platform 12 and brought into the local network. Based on the user's demographic profile, appropriate advertising is chosen by referencing the client database records 68 of platform database 36.

FIG. 9A shows the specific system configuration of interactive advertising system 10 where a client with an associated handheld device 16 interacts with advertising platform 12. The client's handheld device 16 is connected through a local area communication network to advertising platform 12 through RF module 32 (i.e. utilizing the well known Bluetooth communication protocol). Again, this network can be set up within a particular mobile transport unit (in the case of a mobile advertising platform 12) or within a particular physical area around a stationary advertising platform 12. Advertising platform 12 is coupled to advertising server 22 through communications network 20, which can comprise a plurality of cellular towers 40 and an Internet connection 21, as shown. Also, it is noteworthy that a number of Location Information Service (LIS) providers 39 are used to determine the geographical location of the client and/or advertising platform 12.

FIG. 9B shows the event flow amongst handheld device 16, advertising platform 12, advertising server 22 and LIS server 39 in the case of a user event within interactive advertising system 10. The operation of a client query is triggered by the proximity between a Bluetooth enabled handheld device 16 and advertising platform 12. When the client (and their handheld device 16) comes into proximal contact with advertising platform 12 a conventionally known Service Discovery Protocol will occur. This is a process by which devices and services in the network can locate, gather, and make use of other services in the network and help enable the self-configuration in a peer-to-peer network that forms on an ad-hoc basis. Handheld device 16 has a 48-bit address that is statically inserted into it at time of manufacture. This integer value is considered to be globally unique amongst Bluetooth enabled devices. According to the Bluetooth protocol, one device can invite another device to join its network (known as a piconet). One of the pieces of information exchanged during this process is the BD_ADDR (the GUID) which is recorded by interactive advertising system 10 and treated as the Client_ID.

Thus, client interaction can be limited to the situation where handheld device 16 is the proximity of advertising platform 12, whereupon interactive advertising system 10 will correctly identify the client in possession of handheld device 16 using the Client_ID (i.e. the BD_ADDR). Platform controller 24 will then query advertising database 13 which causes the location of the client to be registered and periodically thereafter platform controller 24 will execute the queries stored within the Target Audience database 66. These queries are performed on the records within the Client database 68 stored on advertising platform 12. Actual client interaction with the advertising platform 12 in the form of accepting coupons or requesting information allows the psychographic profile of that user to be enhanced.

Referring to FIG. 9B, once communication between handheld device 16 and advertising platform 12 (through RF module 32) has been established (206), advertising platform 12 queries advertising server 22 (208) which in turn queries the LIS server 39 for location information concerning handheld device 16. This information is returned (209) to advertising server 22 (i.e. longitude and latitude) and this data is entered into client database 84 (i.e. into the LongitudeLatitude value of the client record). This location information on the client is then pushed (210) to advertising platform 12 to update the data in the client database records 68 of platform database 36.

Advertising platform 12 then queries (218) client database 15 on advertising server 22 to obtain information on a particular client. If a match is found, a valid record is returned and entered (219) into client database records 68 of platform database 36. If a match is not found, in client database 15 on advertising server 22 then a dummy record is constructed based upon manual demographic studies and the dummy record is returned and entered into client database records 68 of platform database 36. The dummy entry is based on a calculated statistical “average” rider which is determined on the basis of the geographical location of advertising platform 12 (i.e. which are of the city it is in), the transit route of advertising platform 12, and time and date information.

Periodically queries are sent (214) to platform database 36 by the client's handheld device 16. For each record of target audience database records 66, the stored procedure within Demographic_Query field is executed using information stored in client database 68 (current real riders). For example, the stored procedure to find males between the ages of 17 and 25 maybe executed as illustrated by the following psuedocode:

SELECT Client_ID FROM Client_Database

WHERE Client_Database.Age>17 AND

ClientDatabase.Age<25 AND

ClientDatabase.Gender=‘Male’

This stored procedure in the Demograhpic_Query field will return a record set of Client_IDs. For each record of the target audience database records 66 that returns a favourable result from the stored procedure query, the Advertisement_ID, priority, and the type (i.e. DEMO for a demographic type) are entered (216) into play queue 50 to prepare for display. FIG. 9D shows a play queue 50 where two separate advertisements (i.e. of Type “DEMO”) have been found to match the current demographic query and accordingly have been entered into the queue.

It should be understood that this has been a simplified discussion of how the client event type query operates for illustrative purposes. It is contemplated that client database 15 of administrative server 22 and the client database records 68 of platform database 36 will contain many more fields and be much more comprehensive in the information stored and utilized. For example, psychometric data could be sensed and stored or a client's interest in sports (as indicated by the acceptance of coupons relating to sporting equipment etc.) can be categorized and stored in client database 15. The associated queries could also be expanded to include such additional fields.

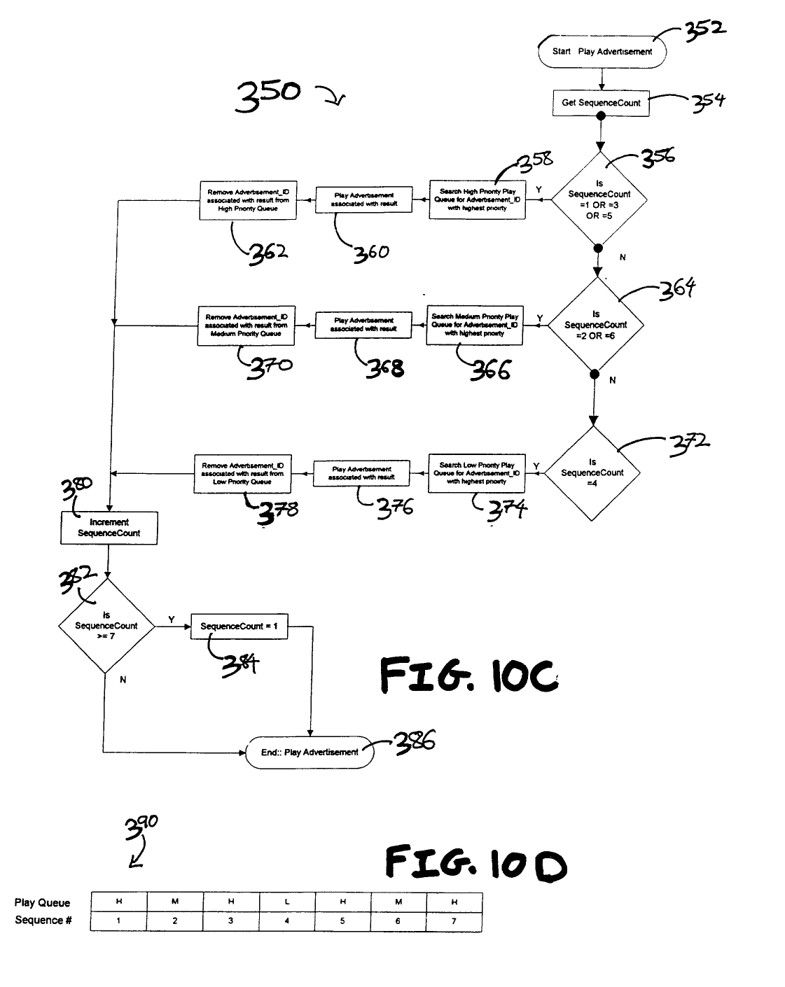

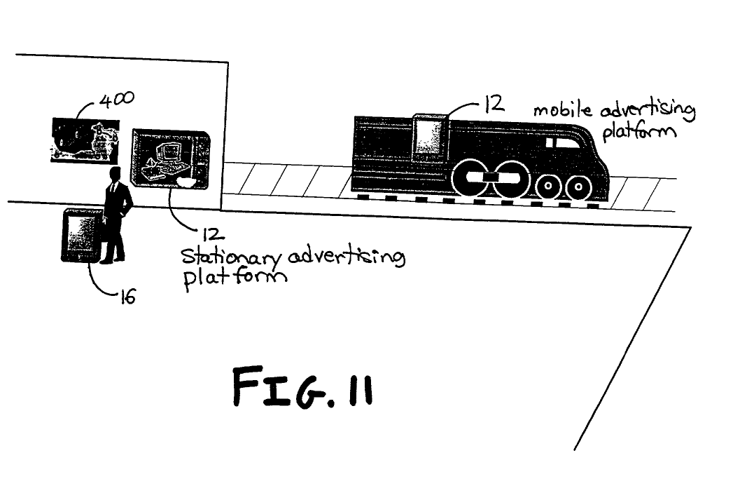

FIG. 10A shows the specific structure of the advertisement queuing records of interactive advertising system 10. As previously discussed, platform database 36 includes play queue 50, high priority play queue 52, medium priority play queue 54 and low priority play queue 56. To ensure all advertisements have the opportunity to be displayed, the entries of play queue 50 are sorted and moved into one of these three other play display queues. Advertisements from these three queues are then selected for display in a round robin fashion, as will be further described.

As previously discussed, an Advertisement_ID may be entered into play queue 50 as a record only if its type is unique. Therefore, only one advertisement entry for time, location and demographic types can exist in play queue 50 for any specific advertisement (i.e. for any particular Advertisement_ID). First, play queue 50 is searched for matching Advertisement_IDs. Next, Advertisment_IDs associated with advertisements are sorted by priority value. The total priority for a specific Advertisement_ID is calculated according to the following algorithm:

TOTALPRIORITY=33−(Priority_{Time}+Priority_{Location}+Priority_{Demographic})

FIG. 10B illustrates the process steps of the QUEUE PLACEMENT routine 300 utilized by platform controller 24 to determine which play queue (i.e. high priority play queue 52, medium priority play queue 54, or low priority play queue 56) a particular Advertisement_ID should be placed into. Generally, this determination is made on the basis of the calculated value of TOTALPRIORITY. It should be noted that the TYPE information is not relevant to the queuing process and is discarded at this point in the queue process.

The queuing process begins when the display of a currently displayed advertisement concludes at step 302. At this point, a new Advertisement_ID must be selected. For each unique Advertisement_ID the TOTALPRIORITY is calculated (304) according to the relation discussed above. It is then determined (306) whether the value of TOTALPRIORITY is greater or equal to 13. If so, then the advertisement is placed (308) in the high priority queue 52 and Advertisement_ID is removed from play queue 50. If not, then it is determined (310) whether the value of TOTALPRIORITY is greater or equal to 5 but less than or equal to 12. If so, then the advertisement is placed (312) in the medium priority queue 54 and Advertisement_ID is removed from play queue 50. If not, then it is determined (314) whether the value of TOTALPRIORITY is less than or equal to 4 in which case the advertisement is placed (316) in the low priority queue 56 and Advertisement_ID is removed from play queue 50.

Finally, once the advertisements have all been categorized within the high, medium and low play queues 52, 54, and 56, the PLAY ADVERTISEMENT routine 350 (see FIG. 10C) is called, to select and play advertisements from the high, medium and low play queues 52, 54, and 56 as will be further described. In this way, advertisements can be selected on an on-going basis depending on the particular location, time and date and client demographic profile and these advertisements can continually be entered into the high, medium and low play queues 52, 54, and 56 and then played by the PLAY ADVERTISEMENT routine.

FIG. 10C illustrates the process steps for the PLAY ADVERTISEMENT routine 350 which define how an Advertisement_ID is selected from the various play queues for playing. Selection of an Advertisement_ID is made from one of the play queues, that is from high priority play queue 52, medium priority play queue 54 or low priority play queue 56. Selection from each play queue depends upon the value of the SeqeuenceCount variable and the sequence pattern 390 as shown in FIG. 10D and as manifested in the logic steps of process steps 350 of FIG. 10C. The SequenceCount variable is incremented as each advertisement is played and reset to 1 if its value exceeds 7. It should be understood that this process is only one implementation of the invention and that there are several other ways of selecting advertisements from the various play queues.

Specifically, the PLAY ADVERTISEMENT routine 350 begins at step 352 and the SequenceCount is obtained (354). When the routine starts for the first time, SequenceCount is first initialized at a value of one. It is then determined whether SequenceCount is equal to one, three or five (356). If so then high priority play queue 52 is searched for an Advertisement_ID with the highest priority (358), the advertisement associated with the result is displayed on platform display 14 (360) and the Advertisement_ID associated with the result is removed (362) from high priority play queue 52. If not, then it is then determined whether SequenceCount is equal to two or six (364). If so, then medium priority play queue 54 is searched for an Advertisement_ID with the highest priority (366), the advertisement associated with the result is displayed on platform display 14 (368) and the Advertisement_ID associated with the result is removed (370) from medium priority play queue 54. If not, then it is then determined whether SequenceCount is equal to four (372). If so then low priority play queue 56 is searched for an Advertisement_ID with the highest priority (374), the advertisement associated with the result is displayed on platform display 14 (376) and the Advertisement_ID associated with the result is removed (387) from low priority play queue 56.

Finally, SequenceCount is incremented (380) and then it is determined whether the SequenceCount is greater than or equal to seven. If so, then the value of SequenceCount is equated to one (384). If not, then the PLAY ADVERTISEMENT routine is finished until the routine is called again by the QUEUE PLACEMENT routine, discussed above. Accordingly, advertisements from high priority queue 52 are selected for display four times in seven playbacks, advertisements from the medium priority queue 54 are selected for display two times in seven playbacks, and advertisements from the low priority queue 56 are selected for display one time every seven playbacks.

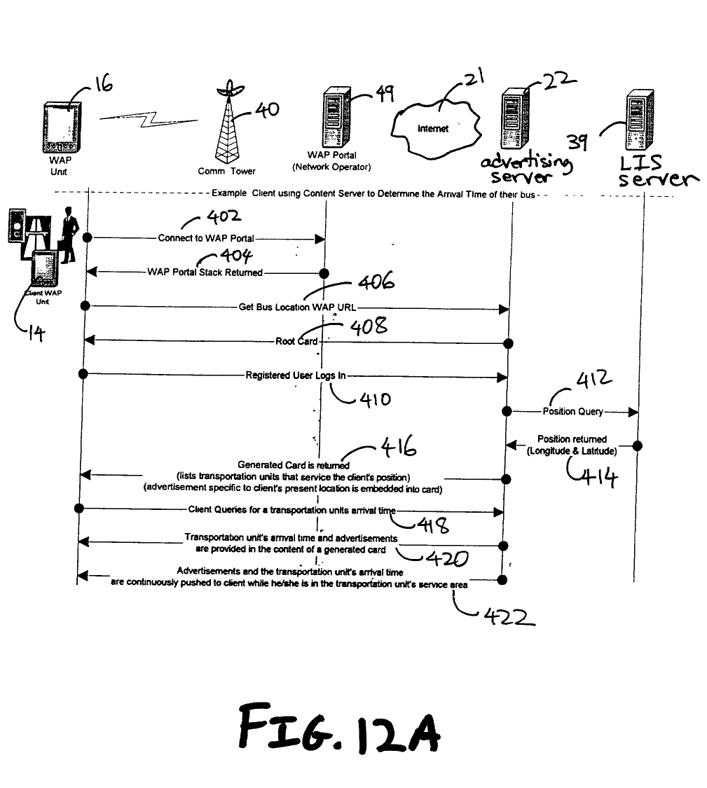

FIG. 11 illustrates one particular client advertisement interaction which is contemplated by the present invention. In this example application, a client has recently departed from a mobile advertising platform 12. This example assumes that the client has interacted with the mobile advertisement platform 12 by accepting coupons that were “pushed” to their handheld device 16 during the display of a particular advertisement.

When the client departs from the mobile advertising platform 12, it is conceivable that the client could remain stationary (i.e. while waiting for a transportation transfer or while reading an information display 400 as shown). If the client is located in close proximity to a stationary advertising platform 12, a local communication connection between stationary advertising platform 12 and handheld device 16 can be initiated. Assuming that the client's handheld device 16 is radio frequency enabled (as it would have had to have been in order to interact with the mobile advertising platform 12) and can be identified by a globally unique identifier. It should be noted that the mere detection of handheld device 16 by stationary advertising platform 12 will result in identification and display of appropriate advertising. It is also possible for the client to interact with interactive advertising system 10 by responding appropriately to interaction prompts on handheld device 16 to create a wireless local area network between the client's handheld device 16 and stationary advertising platform 12.

If the client remains in close proximity to the stationary advertising platform 12 for an extended period of time, then stationary advertising platform 12 will determine that it is worthwhile querying advertising server 22 (not shown) to identify which coupons the client had recently accepted or some other indicia of consumer interest. A favourable result from the query (i.e. if the client has accepted a coupon or if they have a particular purchase history which indicates an interest in sports for example) would result in the presentation of an advertisement that matches the client's previous interests as indicated by the client's previous conduct and as recorded in the client database 15 of advertising server 22.

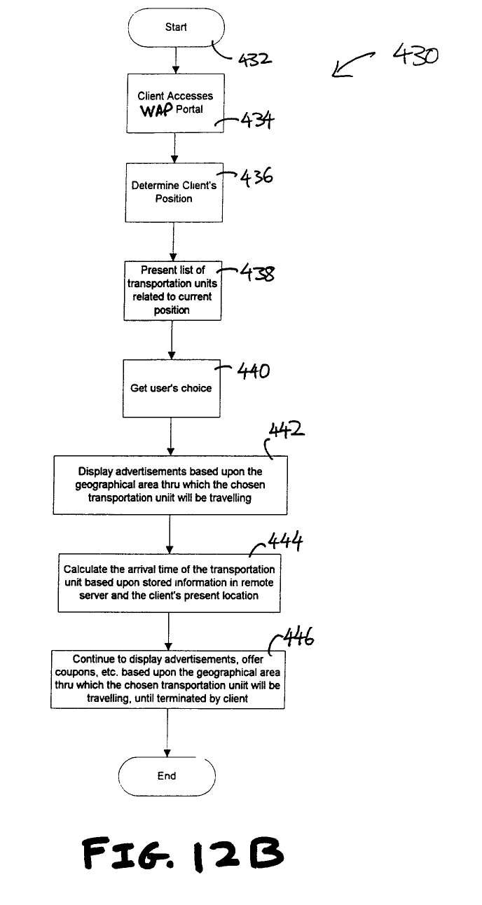

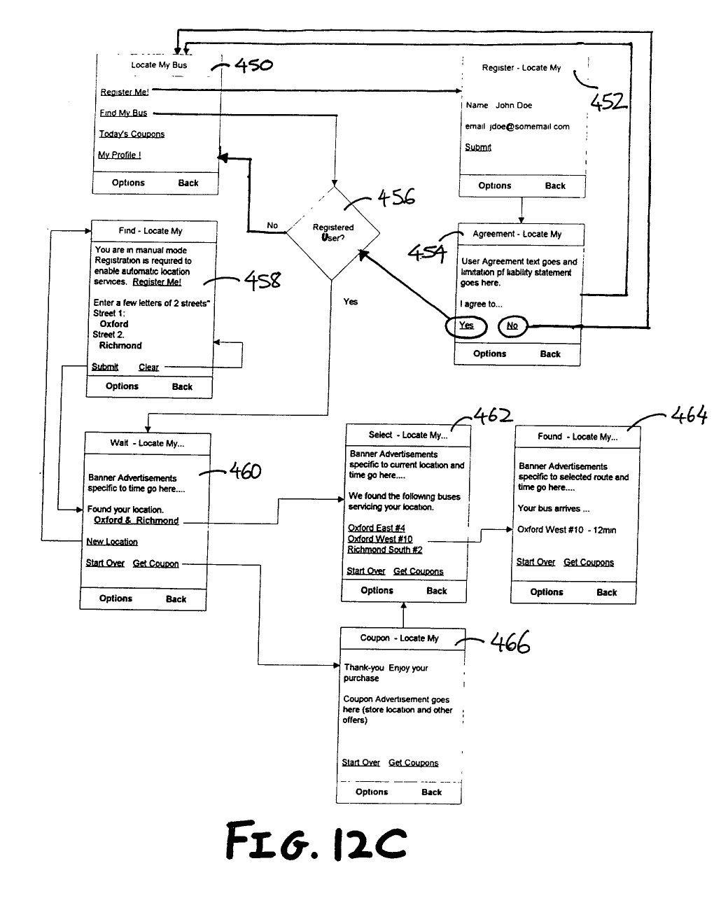

FIGS. 12A, 12B and 12C illustrate another aspect of interactive advertising system 10, wherein a client consults their handheld device 16 to determine the proximity of a mobile advertising platform 12 and an associated transport unit (i.e. a bus or streetcar). In such a case, the client is moving within a geographical area searching for an optimal transportation route while in the possession of a wireless communication handheld device 16.

Essentially, handheld device 16 communicates with advertising server 22 in order to determine the arrival time of various transport units that service their current location and which contain advertising platform 12. It is contemplated that this communication would take place according to the known Wireless Application Protocol (WAP). WAP empowers clients of wireless devices to easily access live interactive information services and applications from the screens of handheld device 16. WAP defines an XML syntax called WML (Wireless Markup Language) and all WML content is accessed over the Internet using standard HTTP 1.1 requests.

FIG. 12A illustrates the interaction of a client having handheld device 16 with advertising server 22 to facilitate the identification and provision of transit geographic and time of arrival information to the client. First, the client connects to advertising server 22 through a wireless network that includes a Wireless Application Protocol (WAP) portal 49. That is, the client uses WAP enabled handheld device 16 to connect to WAP portal 49 using Wireless Session Protocol (WSL) via the cellular communications tower 40. WAP portal 49 returns a “homepage” deck as determined by the network provider which lists the available services and links. The client is required to select the link to the WAP transportation unit location service. This link would specify the Uniform Resource Locator (URL) of advertising server 22.

Accordingly, the client first connects (402) to the WAP portal 49 and the WAP portal 49 returns a data stack (404) to handheld device 16. Once the client confirms their choice to locate a target transport unit through handheld device 16, this information (i.e. a request to obtain a bus location WAP URL) is relayed (406) by WAP portal 49 through the Internet 21 to advertising server 22. Next, a root card is provided back (410) to handheld device 16 and the client logs in (410) to the transportation tracking system of interactive advertising system 10 by providing the appropriate login information to advertising server 22.

The position of handheld device 16 (i.e. and thus the client) is determined by querying (412) LIS server 39 and receiving the longitude and latitude information back (414), as previously discussed. The geographic location of client is used to determine a list of transport units that service the client's present location. Of course, the geographical location information on specific transport units of interest (associated with mobile advertising platforms 12) are also considered in the generation of an information data card that is returned (416) to handheld device 16 for dissemination by client. The information data card contains information such as appropriate transportation units with destination information as well as customized multimedia information that is targeted on the basis of the client's current geographic location.

The client then selects a particular transportation unit on which they would like to travel which causes a query to be sent to (418) advertising server 22 for a particular arrival time. Advertising server 22 then provides (420) the selected transportation unit's arrival time to handheld device 16. Constantly updated arrival time as well as advertisements are continuously “pushed” (422) to handheld device 16 as long as the client remains within the transportation unit's service area. It should be understood that the location information associated with the client and the transportation units associated with advertising platform 12 is all obtained on a real time basis. This feature allows clients to monitor the progress of transportation units and to make decisions based on this information.

During the course of this process, clients will be provided with targeted multimedia presentations on the basis of the client's location and/or their client demographic profiles as stored within client database 15 of advertising server 22. Periodically, customized multimedia information is delivered to the client's handheld device 16 (i.e. new multimedia advertising can be pushed to client's WAP enabled handheld device 16 in response to kinetic and temporal events) while the mobile unit remains in the geographical area serviced by the selected vehicle and/or until a predetermined period of time elapses. The demographic information of the client is also provided to advertising platform 12 of the selected transportation unit and stored in an anonymous format in the client database records 68 (i.e. as an actual rider). The demographic information is retained while client remains in the area serviced by the selected vehicle and/or until a predetermined period of time elapses.

FIG. 12B illustrates the sequence of process steps of the LOCATE MY BUS routine 430 that are required to achieve the aspect of the invention which identifies the geographic and temporal characteristics of target transportation units on behalf of a client. Specifically, the process starts at step 432 when the client indicates some interest on their WAP enabled handheld device 16 to engage in transportation unit observation. The client is then prompted to link to the WAP portal 49 (434) which then determines the client's geographic location (436). A list of potential transportation units is then provided (438) to the client over their handheld device 16, based on the client's particular geographical location.

The client's choice of transport unit is then obtained (440) and advertisements based upon the geographical area through which the chosen transportation unit will be travelling are displayed (442). The arrival time of the transportation unit of choice is calculated based on the real time locations of the transportation unit and of the client (444) and displayed to the client. Advertisements and other promotional content (e.g. coupons) are continually displayed to the client (446) based upon the geographical route through which the chosen transportation unit will be travelling, the time of day, current location of the client, etc. Clients who have registered with the LOCATE MY BUS routine will have a populated demographic record within client database 15 of advertising server 22. As clients register to receive coupons and other promotional incentive products, the coupon database records 64 will also be populated.

FIG. 12C illustrates the screen map which the client would see on their handheld device 16 as they interact with advertising server 22. Once the client evokes the LOCATE MY BUS routine, an initial screen (450) is displayed which provides the client with the option of registering or finding their transportation unit. If the client selects the registration option, they can enter their name and e-mail address (452) and submit the information. The client is then asked to agree to certain waivers (454) and to provide certain demographic information for storage in client database 15 of advertising server 22. The client is assured that none of their personal information is provided or sold to outside agencies through a privacy policy contained in the requisite waivers. If the client does not agree to the terms of the client agreement, then they are returned to the initial screen (450).

After the client registers, or if the client initially chooses to begin locating their transportation unit, advertising server 22 determines whether the client is a registered user (456). If not, then the initial screen (450) is displayed to the user along with a short statement advising them that registration is required to enable participation in the transportation unit location service. If so, then the client is provided with a Locate My Bus interactive screen (46) which provides the client with their location as determined by advertising server 22 as discussed above as well as the option of selecting a new location and obtaining coupons from displayed advertisements.

If the client instead chooses to search for a new location, the system will provide the client with transport unit information based upon an alphanumerically selected location (see screen 458). If the client selects the current location, screen (462) is displayed providing the client with a number of alternative transportation routes (as shown) that service the client's current location. When the client selects one of these options, screen (464) is displayed to the client, which contains banner advertisements as well as arrival information (i.e. 12 minutes to arrival). Finally, if the client wishes to obtain coupons, screen (466) is presented and advertising associated with particular coupons is presented.

Accordingly, interactive advertising system 10 is an advertising system which provides advertisers with the ability to achieve targeted advertising with increased efficiency by providing interaction and gathering of client demographic data on a real time basis in order to continually improve the targeting of advertising to a particular client. In addition, interactive advertising system 10 provides advertisers with the ability to interact with their potential customers and to provide them with interactive benefits such as coupons or useful information. Finally, interactive advertising system 10 is relatively simple and inexpensive to implement within existing technology such as the cellular networks, Internet communications and person digital assistants (PDA) with radio frequency communication facility.

It is contemplated that the advertising provided to a particular client by a mobile advertising platform 12 (e.g. when mounted on a vehicle such as a bus or train) could be further refined by using a plurality of multimedia displays 14 to provide advertising to a client located at a particular location within the vehicle. To accomplish this, advertising platform 12 uses proximity information obtained from RF module 32 to determine where the client is located within the vehicle (e.g. bus back seat) and to provide advertising on a multimedia display 14 which is closest to that particular interior location.

It should be understood that the preceding description has described interactive advertising system 10 as providing targeted advertising content to a client having a handheld device 16 on the basis of three types of discrimination criterion, namely, location of advertising platform 12, time of day, and client demographic characteristics, it should be understood that several other types of discrimination criterion could be utilized by interactive advertising system 10.

It should be understood that various modifications can be made to the preferred and alternative embodiments described and illustrated herein, without departing from the present invention, the scope of which is defined in the appended claims.

We claim:

1. An interactive communication system for providing multimedia content to a client on the basis of a characteristic of the client, the interactive communication system comprising:
(a) a communication server;
(b) a data communication network linked to said communication server;
(c) a handheld device linked to said data communications network;
(d) a communication platform linked to said data communication network, comprising:
(i) a memory for storing the multimedia content and a target client characteristic;
(ii) a processor for determining whether the handheld device is within a predetermined distance of the communication platform;
(iii) a receiver for receiving the characteristic of the client; and
(iv) a display for displaying the multimedia content to the client if the handheld device is within a predetermined distance of the communication system and if the client characteristic is the same as the target client characteristic.

2. The interactive communication system of claim 1, wherein the communication platform includes a transmitter for transmitting data to the handheld device.

3. The interactive communication system of claim 1, wherein the communication platform is mounted on a mobile vehicle.

4. The interactive communication system of claim 3, wherein the mobile vehicle is a bus.

5. The interactive communication system of claim 1, wherein the communication platform includes means for determining geographical position such that the client can receive information on the geographical location of the communication platform.

6. The interactive communication system of claim 5, wherein the multimedia content is correlated to the client's geographical location.

7. The interactive communication system of claim 5, wherein the means for determining geographical position is a global positioning system.

8. The interactive communication system of claim 5, wherein the means for determining geographical position is a cellular triangulation system.

9. The interactive communication system of claim 1, wherein the client characteristic is selected from the group consisting of age, gender, financial income.

10. The interactive communication system of claim 1, wherein the client characteristic is selected from the group consisting of past purchasing history, general interests.

11. The interactive communication system of claim 1, wherein the handheld device is selected from the group consisting of a personal digital assistant, a keyfob, a smart cell phone, laptop computer, and radio frequency enabled devices.

12. The interactive communication system of claim 2, wherein the receiver is also adapted to receive a first set of data signals from the handheld device and the transmitter is adapted to provide a second set of data signals to the handheld device.

13. The interactive communication system of claim 12, wherein the first set of data signals represents a request for a promotional coupon and the second set of data signals represents a promotional coupon.

14. The interactive communication system of claim 12, wherein the first set of data signals represents a request for a first Uniform Resource Locator and the second set of data signals represents a second Uniform Resource Locator.

15. The interactive communication system of claim 14, wherein the first Uniform Resource Locator is the same as the second Uniform Resource Locator.

16. The interactive communication system of claim 1, wherein the receiver is a radio frequency receiver.

17. The interactive communication system of claim 2, wherein the transmitter is a radio frequency transmitter.

18. The interactive communication system of claim 1, wherein the multimedia content is advertising content.

19. The interactive communication system of claim 1, wherein the multimedia content is general interest content.

20. The interactive communication system of claim 1, wherein the handheld device contains programmed instructions to allow the handheld device to:
(i) communicate with the communication server;
(ii) display multimedia content to the client;
(iii) receive client input from the client in response to the multimedia content; and
(iv) transmit the client input to the communication server.

21. The interactive communication system of claim 1, wherein the handheld device is adapted to receive electronic coupons from the communication platform.

22. A method for providing multimedia content from a communication platform to a client on the basis of a client characteristic, the method comprising the steps of:
(a) determining whether the client is within a predetermined distance of the communication platform and whether the client characteristic is the same as the target client characteristic; and
(b) if the determinations in (a) are both positive, then displaying the multimedia content to the client.

23. The method of claim 22, wherein step (b) further includes the steps of:
(a) remotely storing the multimedia content and a target client characteristic; and
(b) transmitting the multimedia content to the communication platform for display to the client if the determinations in (a) are both positive.

24. The method of claim 22, wherein the communication platform is mounted on a mobile vehicle.

25. The method of claim 22, wherein the multimedia content is also related to the client's geographical location.

26. The method of claim 22, wherein the multimedia content is also related to the time of day.

27. The method of claim 22, wherein the communication platform includes means for determining the geographical position of the communication platform and means for transmitting the geographical location of the communication platform to the handheld device.
